(19) United States
(12) Patent Application Publication
(10) Pub. No.: US 2025/0346498 A1
(43) Pub. Date: Nov. 13, 2025

(54) METHODS OF FORMING A CATHODE MATERIAL FROM A TUTTON'S SALT

(71) Applicant: Battelle Energy Alliance, LLC, Idaho Falls, ID (US)

(72) Inventors: John R. Klaehn, Idaho Falls, ID (US); Eric J. Dufek, Ammon, ID (US); Luis A. Diaz Aldana, Idaho Falls, ID (US); Tedd E. Lister, Cotuit, MA (US); Meng Shi, Idaho Falls, ID (US); Bor-Rong Chen, Idaho Falls, ID (US); Pete L. Barnes, Idaho Falls, ID (US)

(21) Appl. No.: 19/203,510

(22) Filed: May 9, 2025

Related U.S. Application Data
(60) Provisional application No. 63/645,602, filed on May 10, 2024.

(51) Int. Cl. C01G 53/506; C01G 53/84; H01M 4/525

(52) U.S. Cl. CPC C01G 53/506; C01G 53/84; H01M 4/525; C01P 2002/50; C01P 2002/72; C01P 2006/40

(57) ABSTRACT

A method of preparing a cathode precursor material comprising combining a Tutton's salt exhibiting the chemical formula (NH₄)₂M(SO₄)₂·6H₂O, wherein M comprises one or more metals, and water to form a Tutton's salt solution, adding a chelating agent to the Tutton's salt solution to form a Tutton's salt/chelating agent solution, and heating the Tutton's salt/chelating agent solution to form a cathode precursor material comprising a mixed metal composition of the Tutton's salt. Additional methods are disclosed.

### CROSS-REFERENCE TO RELATED APPLICATION

This application claims the benefit under 35 U.S.C. § 119(e) of U.S. Provisional Patent Application Ser. No. 63/645,602, filed May 10, 2024, the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

This disclosure relates generally to processes for forming cathode materials. In particular, embodiments of the disclosure relate to methods for forming a cathode material from a Tutton's salt.

### BACKGROUND

Metals, such as nickel (Ni) and cobalt (Co), among others, are important components in several supply chains including energy storage (e.g., batteries), super alloys, transportation, and construction materials. There is a high demand for Ni and Co for the electric vehicle market. Lithium-nickel-manganese-cobalt-oxide (LiNiMnCoOₓ), abbreviated NMC or lithium-NMC, is frequently used as a cathode material in lithium-ion batteries. NMC cathodes may provide an energy capacity of about 300 Wh/kg in lithium-ion batteries. This high level of energy density is desired for the development of next generation electric vehicles. Ni and Co may be in short supply and may have insecure supply chains. Co resources are scarce, costly, and may be sourced from economically unstable regions. The cost of nickel has also increased substantially.

### BRIEF SUMMARY

A method of preparing a cathode precursor material is disclosed. The method comprises combining a Tutton's salt exhibiting the chemical formula (NH₄)₂M(SO₄)₂·6H₂O, wherein M comprises one or more metals and water to form a Tutton's salt solution; adding a chelating agent to the Tutton's salt solution to form a Tutton's salt/chelating agent solution; and heating the Tutton's salt/chelating agent solution to form a cathode precursor material comprising a mixed metal composition of the Tutton's salt.

Also disclosed is a method of preparing a cathode precursor material comprising combining a Tutton's salt comprising the chemical formula (NH₄)₂M(SO₄)₂·6H₂O, wherein M comprises nickel and cobalt in water to form a Tutton's salt solution. Oxalic acid is added to the Tutton's salt solution to form a Tutton's salt/oxalic acid solution. The Tutton's salt/oxalic acid solution is heated to form a cathode precursor material comprising nickel and cobalt.

Also disclosed is a method of preparing a cathode precursor material comprising dissolving a Tutton's salt in water or in ethylene glycol and water to form a Tutton's salt solution; adding a chelating agent comprising one or more of citric acid and oxalic acid to the Tutton's salt solution to form a Tutton's salt/chelating agent solution; and heating the Tutton's salt/chelating agent solution to form a cathode precursor material comprising a mixed metal composition.

### BRIEF DESCRIPTION OF THE DRAWINGS

For a detailed understanding of the disclosure, reference should be made to the following detailed description, taken in conjunction with the accompanying drawings, in which like elements have generally been designated with like numerals, and wherein:

FIG. 1 is a flow chart illustrating acts of forming a cathode precursor material from a Tutton's salt and utilizing the cathode precursor material to prepare a cathode of an energy storage device in accordance with embodiments of the disclosure.

FIG. 2 is an image of a lamination of a nickel-manganese-cobalt (NMC) material formed from a Tutton's salt in accordance with embodiments of the disclosure.

FIG. 3 is an image of a lamination of an NMC material formed from conventional sulfate salts.

FIG. 4 shows an x-ray diffraction (XRD) pattern of a calcined nickel-manganese-cobalt material formed from a Tutton's salt in accordance with embodiments of the disclosure.

FIG. 5 is an image of a lamination of an NMC material formed from a Tutton's salt and a button cell prepared with the NMC material in accordance with embodiments of the disclosure.

FIG. 6 is a graph showing voltage (V) versus capacity (mAh g⁻¹), an XRD pattern, and a scanning electron microscope image of calcined NMC particles for a battery cathode prepared from conventional individual nickel sulfate, manganese sulfate, and cobalt sulfate.

FIG. 7 is a graph showing voltage (V) versus capacity (mAh g⁻¹), an XRD pattern, and a scanning electron microscope image of calcined NMC particles for a battery cathode prepared from a battery cathode prepared from Tutton's salt in accordance with embodiments of the disclosure.

### DETAILED DESCRIPTION

The illustrations presented herein are not actual views of any method, material, cathode, battery, or any component thereof, but are merely idealized representations, which are employed to describe embodiments of the invention.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise. For example, these terms may refer to an orientation of elements of any battery or battery component when utilized in a conventional manner. Furthermore, these terms may refer to an orientation of elements of any battery or battery component as illustrated in the drawings.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.). For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

Described is a method of forming materials from metal salts known as double salts or Tutton's salts. In embodiments of the disclosure, the method comprises utilizing a Tutton's salt to prepare a cathode material, such as a lithium-ion battery cathode material (e.g., a nickel-manganese-cobalt (NMC) cathode material), of an energy storage device (e.g., a battery).

The battery materials (e.g., cathode materials) may be utilized in various applications, such as in cathode production for lithium-ion batteries. The method enables relieving or alleviating nickel (Ni) and cobalt (Co) supply chain insecurities by providing a cathode material that is prepared from the Tutton's salt. In embodiments of the disclosure, the Tutton's salt is sourced and/or prepared from metals recovered from recycled waste (e.g., lithium-ion battery waste).

A Tutton's salt has a general formula of (NH₄)₂M(SO₄)₂··6H₂O, where “M” is generally a divalent transition metal comprising two transition metals to form a double salt. The Tutton's salt may also include more than two transition metals. A mixed Tutton salts may comprise the divalent metal site partially occupied by two or more different divalent metal ions. In some embodiments, M is Ni and Co. In other embodiments, M is Ni, Co, and Mn. As used herein, the terms “Tutton's salt” and “double salt” may be used interchangeably. As used herein, the terms “cathode material” and “cathode precursor material” may be used interchangeably to refer to the material prepared from the Tutton's salt.

A Tutton's salt including nickel and cobalt may be formed by the following exemplary reaction:

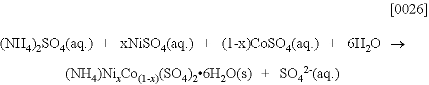

where x is a real number, aq.=aqueous, and s=solid. In some embodiments, x is between 0 and 1, where x is the percentage (real number) of nickel, and cobalt is the remainder of that percentage to give 100% of the total metal sulfate in the Tutton's salt.

The metals (e.g., nickel and cobalt) used to prepare the Tutton's salt may be obtained from any desired source, such as a commercially available metal source or a recycled metal source. For each source, the atomic ratio between the metals (e.g., between Ni and Co) in the resulting Tutton's salt is tunable (e.g., tailorable) based on the chemical composition of reagents used to prepare the Tutton's salt. In embodiments, the Tutton's salt may be prepared from metal(s) obtained from a metal recovery process. For example, metals, such as Ni manganese (Mn), and Co, among others, may be isolated and recovered from various sources including, but not limited to, mining waste, scrap metal, electronic waste, and recycled battery materials, e.g., end-of-life lithium-ion battery waste. The metals may be recovered from the waste and used to prepare the Tutton's salt. The cathode precursor material, such as an NMC cathode precursor material, may be prepared from the Tutton's salt, which, in turn, is prepared from metals recovered from the mining waste, scrap metal, electronic waste, and recycled battery materials. Alternatively, the Tutton's salt may be prepared from commercially available metals.

The cathode material may be prepared from the Tutton's salt, which is prepared from metals recovered from waste recycled from spent lithium-ion batteries. Lithium-ion battery black mass is primarily a mixture of shredded battery materials including anode materials, cathode materials and current collector foils, which may be processed by recycling companies. The black mass may contain, for example, one or more of aluminum, copper, iron, lithium, manganese, cobalt, nickel, and graphite. One or more of copper foils, aluminum foils, graphite, polymers, and electrolyte may be recovered from the black mass, such as by physical separation. The graphite may be recovered, such as by leaching with mineral acids. The metals may be recovered from the black mass, such as by electrochemically leaching, to produce a metal leachate solution. The metal leachate solution may be a lithium-ion battery leachate that includes one or more of iron, aluminum, nickel, manganese, cobalt, and other metals and/or other materials The Tutton's salt may be prepared from metals precipitated out from the metal leachate solution. The metals used to prepare the Tutton's salt metals may, for example, be obtained as described in PCT/US2022/076134, of John R. Klaehn, et al., entitled “Methods of Separating Metals from a Lithium Ion Battery Leachate,” which is hereby incorporated by reference herein in its entirety. As described in PCT/US2022/076134, metals may be separated from a waste metal source, such as a lithium-ion battery leachate, to obtain a solution including one or more of iron, aluminum, nickel, manganese, cobalt, other metals, and/or other materials. Certain metals, such as aluminum, may be removed from the solution. For example, the solution pH may be adjusted by addition of ammonium phosphate to precipitate one or more phosphate compounds out of solution, such as to precipitate one or more of iron phosphate and aluminum phosphate out of solution. The iron phosphate and aluminum phosphate may, for example, be filtered from the solution. Then, a crystallized Tutton's salt, such as a nickel-cobalt Tutton's salt, may be precipitated from the solution. In embodiments, ammonium sulfate may be used to precipitate the Tutton's salt from the solution.

As noted, Tutton's salt may have the formula (NH₄)₂M(SO₄)₂·6H₂O, where M is a mixed transition metal composition. In embodiments, M comprises at least two metals selected from nickel, cobalt, and manganese. In certain embodiments, M comprises Ni and Co to provide a Ni/Co Tutton's salt. In other embodiments, M comprises Ni, Mn, and Co to provide a Ni/Mn/Co Tutton's salt. The solubility of the metals in solution may determine the composition of the formed Tutton's salt. Conditions such as pH, temperature, and concentrations of components (e.g., the metals) may also affect the composition of the formed Tutton's salt. For example, Ni is less soluble than Co while Mn is more soluble than Ni and Co (using ammonium sulfate as a reference to the Ni, Co, and Mn sulfate salts). Therefore, in an aqueous solution comprising MnSO₄, CoSO₄, and NiSO₄, the metals will have a solubility wherein Mn solubility is relatively higher than Co solubility and Co solubility is relatively higher than Ni solubility. Therefore, the resulting Tutton's salt composition may have a greater relative amount of Ni compared to Co and Mn under these conditions. Table 1 shows equilibrium solubility concentrations at 25° C. of sulfate salts (kg of salt/kg of water).

TABLE 1

| Ammonium Sulfate | Solubility (kg/kg water) |
|---|---|
| (NH₄)₂SO₄ | 0.760^{a} |
| (NH₄)₂Ni(SO₄)₂•6H₂0 | 0.075^{b} |
| (NH₄)₂Co(SO₄)₂•6H₂0 | 0.147^{c} |
| (NH₄)₂Mn(SO₄)₂•6H₂0 | 0.372^{c} |

^{a}Inorganic salt solubility constants, CRC Handbook of Chemistry and Physics and Lange's Handbook of Chemistry.
^{b}Mullin, J. W., Osman, M. M., 1967, J. Chem. Eng. Data 12, 516-517.
^{c}Seidell, A., 1919, Solubilities of Inorganic and Organic Substances: A Compilation of Quantitative Solubility Data from the Periodical Literature, D. Van Nostrand Company.

The resulting Tutton's salt has a composition that is dependent on the metal concentrations of the original leachate solution, which may comprise any ratio of metals depending on the desired composition of the cathode precursor material. One or more additional metal sulfate salts (e.g., NiSO₄, CoSO₄, MnSO₄) may be added to the Tutton's salt to achieve the desired cathode composition. The Tutton's salt may comprise the desired metal ratio, such as any desired nickel: cobalt (Ni:Co) ratio or nickel:manganese:cobalt (Ni:Mn:Co) ratio. The composition of the metals in the Tutton's salt can be assessed, such as by flame atomic adsorption, energy dispersive spectroscopy, or X-ray fluorescence. By appropriately selecting a metal feedstock having a desired chemical composition and using the metal feedstock to prepare the Tutton's salt, the desired composition of the final cathode precursor material prepared with the Tutton's salt may be achieved. That is, the metal content in the Tutton's salt, for example, the ratio of Ni:Co, may be tunable through the metal feedstock concentration utilized to prepare the Tutton's salt. The formation of the Tutton's salt will preferentially crystallize Ni, resulting in a higher recovery of Ni over Co compared with the starting metal feedstock. This enables production of a high Ni content NMC cathode material from the Tutton's salt. By way of example, the Tutton's salt may comprise a nickel: manganese: cobalt (NMC) salt or a nickel: cobalt (Ni:Co) salt at any desired ratio of Ni:Mn:Co or Ni:Co by appropriately selecting the metal feedstock. For cathode materials where a high nickel content is desired, a greater amount of nickel may be present in the Tutton's salt feedstock relative to cobalt, so as to prepare a cathode material from the Tutton's salt where the cathode material has a Ni:Mn:Co ratio of 8:1:1 or 6:2:2 or a Ni:Co ratio of 8:1 or 6:2, although not limited. In some embodiments, the Tutton's salt includes about 85% nickel and about 15% cobalt.

In addition to tuning the Tutton's salt composition by selecting the concentration of metals in the feedstock used to prepare the Tutton's salt, the Tutton's salt composition may be tunable by adding one or more additional metals or metal materials to the feedstock (e.g., feedstock from recycled lithium-ion batteries). Additional metal sulfate may be added to the Tutton's salt feedstock to increase the content of a desired metal in the Tutton's salt. For example, one or more of nickel sulfate, manganese sulfate, and cobalt sulfate may be added to the feedstock to increase the concentration of one or more of nickel, manganese, and cobalt in the Tutton's salt. Further, additional Tutton's salt may be added to the starting Tutton's salt feedstock to reach a desired metal content, such as a desired Ni:Mn:Co ratio, in the Tutton's salt and therefore in the cathode material prepared from the Tutton's salt. The flexibility in chemical composition of the initial feedstock in combination with the optional addition of one or metals as desired enables a Tutton's salt and eventual final material (e.g., cathode precursor material) prepared from the Tutton's salt having any desired metal composition.

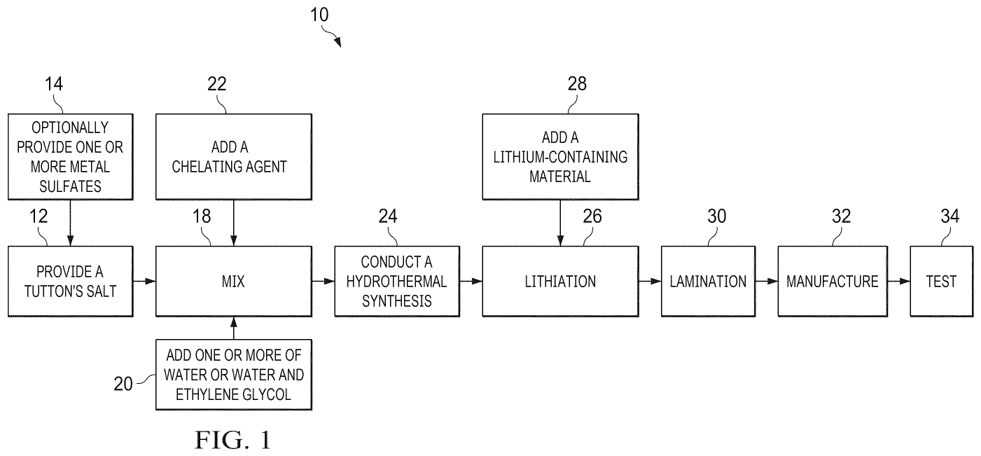

The method herein comprises utilizing the Tutton's salt to prepare an NMC cathode precursor material. In embodiments, the Tutton's salt is prepared from metals recovered from waste, such as from lithium-ion battery waste. Turning to FIG. 1, a method 10 for preparing a material (e.g., a cathode precursor material) from a Tutton's salt includes providing a Tutton's salt (act 12). The Tutton's salt of act 12 may be a recycled Tutton's salt. That is, the Tutton's salt may be prepared from metals obtained from recycled materials, such as metals obtained from a lithium-ion battery waste leachate. The method 10 may optionally include providing another source of Tutton's salt (act 12), such as a Tutton's salt prepared from commercially available, “off the shelf” metals. The Tutton's salt in act 12 may exhibit the desired metal ratio, such as the desired nickel:cobalt (Ni:Co) ratio or nickel:manganese:cobalt (Ni:Mn:Co) ratio. Alternatively, one or more metal sufates, such as one or more of nickel sulfate salt, manganese sulfate salt, and/or cobalt sulfate may be added (act 14) to the Tutton's salt to achieve the desired nickel:cobalt (Ni:Co) ratio or nickel:manganese:cobalt (Ni:Mn:Co) ratio in the cathode precursor material.

The method may include combining (e.g., mixing) (act 18) the Tutton's salt and a solvent (e.g., water or water and ethylene glycol) to form a Tutton's salt solution. Combining (act 18) (e.g., mixing) may be conducted, such as with stir bars, for any desired amount of time, such as from about 1 hour to about 10 hours. The mixing may be done at ambient pressure.

Mixing (act 18) may include combining the Tutton's salt with water (e.g., deionized water) or water and ethylene glycol (act 20) to substantially completely dissolve the Tutton's salt in the one or more of water and ethylene glycol to form the Tutton's salt solution. In embodiments of the disclosure, the Tutton's salt is dissolved in a solution comprising a combination of ethylene glycol and water. The ethylene glycol and water may be provided at a volumetric ratio of 1:1 ethylene glycol: water or 2:1 ethylene glycol: water, although not limited. The Tutton's salt solution may be heated to dissolve the Tutton's salt.

A chelating agent may be utilized to help dissolve the Tutton's salt and/or assist in crystallization of the metals to form the cathode precursor material. The method 10 may include adding a chelating agent (act 22) to the Tutton's salt solution. The chelating agent may comprise one or more of ethylenediaminetetraacetic acid, citric acid, fulvic acid, phytic acid, gluconic acid, nitrilotriacetic acid, lactic acid, acetic acid, malic acid, oxalic acid, tartaric acid, lactic acid, picolinic acid, ascorbic acid, and formic acid. In embodiments of the disclosure, the chelating agent may be one or more of citric acid and oxalic acid. Without wishing to be bound by theory, addition of oxalic acid may push the equilibrium toward the dissolution of the Tutton's salt. The Tutton's salt is formed, such as by the exemplary reaction to forming a nickel-cobalt Tutton's salt shown hereinabove, and the reverse reaction shows the Tutton's salt dissolution. Oxalic acid precipitates transition metal ions such that a greater amount of the Tutton's salt will dissolve. Although both Tutton's salt and metal oxalates are solid materials, utilizing the metal oxalate may render the subsequent acts in the cathode precursor synthesis easier. In embodiments, the oxalic acid may be combined with the Tutton's salt solution at ambient pressure to form a Tutton's salt/oxalic acid solution. The oxalic acid may be added at a molar ratio of about 1.5:1.0 oxalic acid:TM, wherein TM=Ni+Mn+Co. The Tutton's salt/chelating agent solution may have a 1 mol/L metal concentration, although not limited.

A solution-based synthesis may be conducted using the Tutton's salt/chelating agent solution to form the cathode precursor material. The method comprises a solution-based synthesis, which may be termed a hydrothermal synthesis or a hydrothermal co-precipitation synthesis. The hydrothermal synthesis may be conducted (act 24) to form a solid material (e.g., a cathode precursor material) from the Tutton's salt.

In conventional methods, individual cobalt sulfate and nickel sulfate have been used to prepare a NMC cathode material. That is, cobalt sulfate and nickel sulfate have been provided as separate ingredients. In the conventional methods, sulfate (SO₄²⁻), nitrate (NO³⁻), or metal oxides of Ni, Co, and Mn may be provided at a desired ratio and dissolved in aqueous solutions with controlled pH, temperature, and pressure to allow NMC compounds to crystallize. The conventional reaction may be as follows:

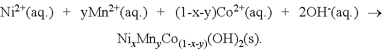

For conventional hydrothermal synthesis or co-precipitation synthesis of NMC cathode materials, stoichiometric amounts of Ni, Co, and Mn sulfate salts (MSO₄), or other salt species such as M(CH₃COO)₂, MNO₃ (where M=Ni, Co, Mn) may be dissolved into deionized water. The pH in the aqueous solution may be adjusted for NMC solid crystals to be precipitated from the solution at elevated temperature or pressure.

In contrast, embodiments of the disclosure include preparing a cathode material from a Tutton's salt rather than from individual sulfate salts. In the method 10, the pH of the Tutton's salt solution may be allowed to adjust naturally as a result of combining the chelating agent into the Tutton's salt solution. The hydrothermal synthesis (act 24) may comprise heating the Tutton's salt/chelating agent solution to a suitable temperature. By way of example, the Tutton's salt/chelating agent solution may be heated to a temperature of from about 30° C. to about 100° C. In embodiments, the Tutton's salt/chelating agent solution may be heated to a temperature below about 100° C. The reaction in embodiments of the disclosure may be as follows:

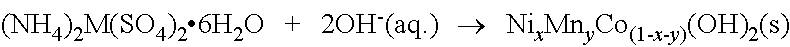

where (NH₄)₂M(SO₄)₂·6H₂O is a Tutton's salt, and M is selected from Ni, Co, and Mn.

For the hydrothermal synthesis (act 24) of the cathode precursor material, the Tutton's salt/chelating agent solution may be heated in a sealed vessel under pressure. The Tutton's salt/chelating agent solution may be heated to a temperature of from about 100° C. to about 250° C. in a sealed vessel, such as an autoclave. The vessel may be maintained under pressure, such as a pressure of from about 5 atmospheres to about 20 atmospheres, to assist in crystallization of the Tutton's material to form the cathode precursor material, such as NMC solid, from the Tutton's salt.

One or more of pH and temperature may be adjusted during the hydrothermal synthesis (act 24) to precipitate a solid material from the Tutton's salt/chelating agent solution (e.g., Tutton's salt and oxalic acid solution). The pH may be allowed to adjust naturally without any specific addition of acid or base. The final pH may be from about 0.5 to about 1.5. The Tutton's salt/chelating agent solution in the vessel may be placed in a sealed autoclave, such as a polytetrafluoroethylene lined autoclave from PARR® Instrument Company, at a temperature of from about 100° C. to about 250° C., or from about 150° C. to about 200° C., and held for a duration of from about 4 hours to about 20 hours, or from about 6 hours to about 15 hours, or from about 8 hours to about 12 hours, although not limited. The temperature within the vessel may be incrementally increased, such as at about 2° C. per minute. The temperature may subsequently be incrementally decreased, such as at about 1° C. per minute. The vessel may be allowed to cool to room temperature (such as from about 15° C. to about 25° C.). The solid material formed during the hydrothermal synthesis (act 24) (e.g., NMC solid/cathode precursor material) prepared from the Tutton's salt may then be used for any desired application, such as to prepare a cathode for a lithium-ion battery.

The NMC cathode precursor material prepared from the Tutton's salt may be used instead of a conventional NMC cathode material prepared from individual metal sulfates (e.g., cobalt sulfate and nickel sulfate). Along with the tunability of the metal content in the Tutton's salt (e.g., the Ni:Co ratio or Ni:Mn:Co ratio), adjustments to produce desired Ni:Mn:Co ratios may be utilized, such as by adding one or more metals or materials to the feedstock as described above, to obtain a cathode precursor material having the desired metal content. Conventionally, Ni and Co may comprise about 50% of the mass of an NMC cathode material and may comprise about 51% of the overall cost of a typical lithium-ion battery. To reduce the amount of Co, a cathode may comprise an increased Ni content of from about 60 weight percent to about 90 weight percent Ni. The method according to embodiments of the disclosure enables use of metals obtained from recycled materials alleviating or eliminating altogether the need for non-domestic sources of metals such as Ni, Co, and Mn.

The solid material (e.g., cathode precursor material) prepared from the Tutton's salt may be combined (e.g., mixed) with another material to produce the cathode. Returning to FIG. 1, lithiation (act 26) of the cathode precursor material prepared from the Tutton's salt may include combining (e.g., mixing) (act 28) the cathode precursor material with a lithium-containing material, such as one or more of LiOH or Li₂CO₃, to form lithium-metal particles. The lithium-containing material (e.g., LiOH or Li₂CO₃) may be provided in a molar ratio relative to the total Tutton's metals of Li:TM 1.05:1.0 molar ratio, where TM=the total ratio of metals in the solid Tutton's material (e.g., Ni+Mn+Co in the solid Tutton's material). The solid cathode precursor material prepared from the Tutton's salt may be mixed with the lithium-containing material (e.g., LiOH or Li₂CO₃). Lithiation (act 26) may comprise heating (e.g., calcining) to obtain particles of Li-metal (e.g., lithium-NMC particles). Heating may comprise heating to a temperature of from about 400° C. to about 950° C., or from about 750° C. to about 950° C., or from about 850° C. to about 900° C., for a period of from about 2 hours to about 25 hours, or from about 5 hours to about 18 hours, or from about 5 hours to about 16 hours. Heating may comprise heating to a first, lower temperature, for a first period of time, followed by heating to a second, higher temperature, for a second period of time. For example, the solid material may be heated to a temperature of from about 400° C. to about 500° C. for a period of from about 2 hours to about 6 hours, followed by heating to a temperature of from about 850° C. to about 900° C. for a period of from about 14 hours to about 18 hours. When increasing the temperature, the temperature may be ramped up incrementally, such as by about 2° C. per minute. After formation of the lithium-metal particles (e.g., lithium-NMC particles), the temperature may be ramped down or the particles may be allowed to cool to room temperature uncontrolled (e.g., not ramped down incrementally). X-ray Diffraction (XRD) and Scanning Electron Microscopy (SEM) may be utilized to characterize the lithium-metal particles (e.g., lithium-NMC particles).

The lithium-metal particles may be used to form a battery cathode such as a cathode for a lithium-ion battery according to known battery formation techniques. The lithium-NMC particles may, for example, be blended into a slurry with carbon (e.g., conductive carbon) and a polymer-based binder to form a lithium-NMC particle-binder composition. The slurry may be coated onto a substrate (e.g., a current collector, such as an aluminum current collector). The current collector may, for example, be configured as a sheet. For example, the lithium-NMC particles may be combined with a binder, such as a polyvinylidene fluoride (PVDF) binder, and coated onto the current collector, such as an aluminum current collector. The lithium-NMC particles may be applied to the current collector at any suitable amount. In embodiments, the lithium-NMC particles may be provided at a loading of from about 3.6 mg/cm² to about 4.2 mg/cm². Returning to FIG. 1, lamination (act 30) of the lithium-metal particles may be conducted to adhere the lithium-metal particle-binder composition to the substrate. The lithium-metal particles (e.g., lithium-NMC particles) and binder may form a coating having a desired thickness on the substrate.

The cathode material prepared from the Tutton's salt may be readily laminated, similar to cathode materials prepared from conventional, individual sulfate salts. The method may further include manufacturing (act 32) a battery using a cathode prepared with the Tutton's cathode precursor material. By way of example only, a lithium-NMC coin cell may be produced, such as by carving out 12-millimeter cathode disks from the lithium-NMC coated aluminum described above. The cathode disks may then be used for subsequent battery assembly according to known battery assembly procedures. The cathode may be produced at any suitable thickness. In embodiments, the cathode may be produced at a total electrode thickness of from about 30 micrometers to about 60 micrometers or from about 40 micrometers to about 55 micrometers. Cathode testing (act 34) may be conducted to determine various cathode characteristics.

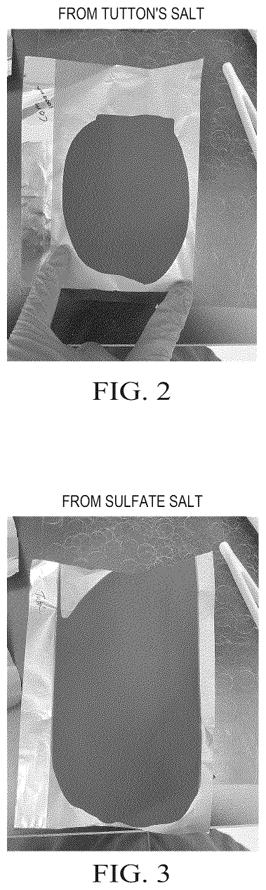

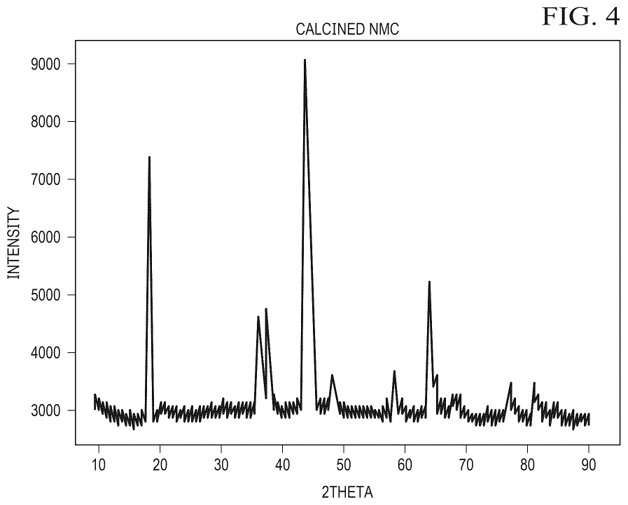

FIG. 2 is a photograph of a Tutton's cathode material (e.g., a lithium-NMC particle binder composition) prepared in accordance with embodiments of the disclosure and laminated to aluminum (e.g., an aluminum substrate). FIG. 3 is a photograph of a conventional cathode material prepared from individual sulfate salts laminated to aluminum (e.g., an aluminum substrate). In each case, the laminated material included 80% by weight lithium-NMC cathode material, 10% by weight PVDF binder, and 10% by weight SUPER P® conductive carbon.

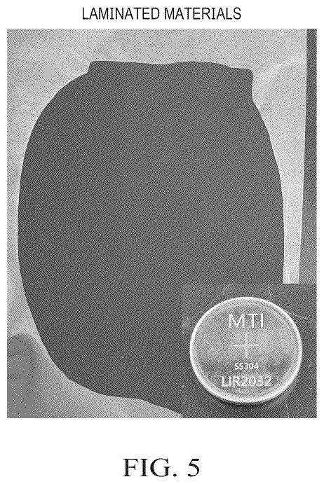

FIG. 4 shows an x-ray diffraction (XRD) pattern for a calcined nickel-manganese-cobalt (NMC) material prepared in accordance with embodiments of the disclosure. FIG. 5 is an image of a lamination of an NMC material formed from a Tutton's salt and a button cell prepared with the NMC material in accordance with embodiments of the disclosure.

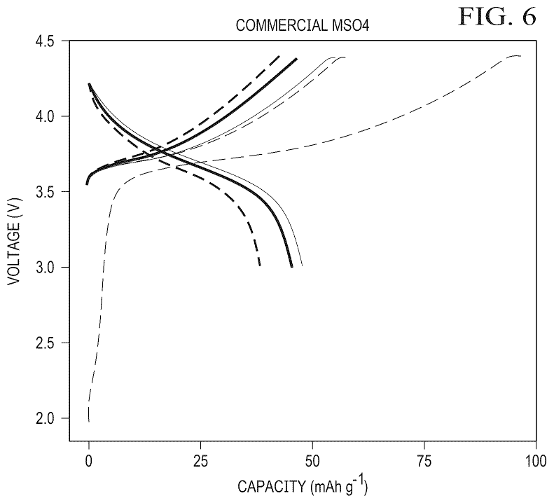

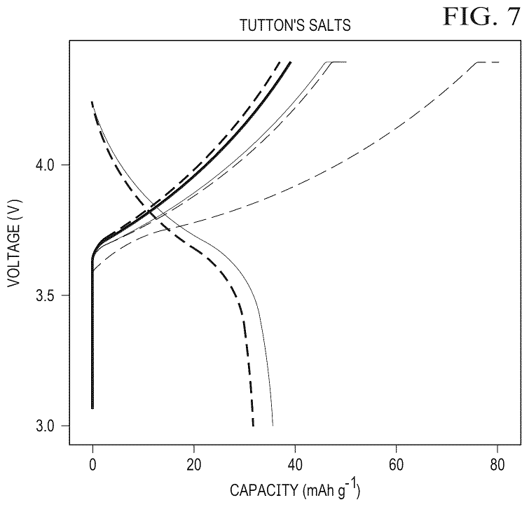

FIGS. 6 and 7 show test results of a battery having a cathode formed from a Tutton's salt in accordance with embodiments of the disclosure (FIG. 7) compared to a battery having a cathode prepared from conventional nickel sulfate, manganese sulfate, and cobalt sulfate (FIG. 6). FIG. 6 is a graph showing voltage (V) versus capacity (mAh g⁻¹), an XRD pattern, and a scanning electron microscope image for a battery cathode prepared conventionally from individual nickel sulfate, manganese sulfate, and cobalt sulfate. FIG. 7 is a graph showing voltage (V) versus capacity (mAh g⁻¹), an XRD pattern, and a scanning electron microscope image for a battery cathode prepared from a cathode material prepared from a Tutton's salt in accordance with embodiments of the disclosure. The performance of the battery cathode prepared from the cathode material prepared from a Tutton's salt in accordance with embodiments of the disclosure met or exceeded the performance of the battery cathode prepared with the conventional individual metal sulfates.

Thus, methods for cathode material formation and cathode production are provided which enable feedstock flexibility by use of a Tutton's salt, which may be supplied from commercial materials or from recovered materials. The chemical composition of the Tutton's salt may be tuned by selection of the feedstock, and optional additions of chemical compounds to the Tutton's salt feedstock, to provide a cathode material having a desired metal content. The method comprises utilizing recovered metals, which may strengthen the domestic supply for lithium-ion battery cathodes while contributing to a clean energy economy. In addition, national security issues relating to lack of a domestic supply chain may be reduced or alleviated.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A method of preparing a cathode precursor material, the method comprising:
combining a Tutton's salt exhibiting the chemical formula (NH₄)₂M(SO₄)₂·6H₂O, wherein M comprises one or more metals, and water to form a Tutton's salt solution;
adding a chelating agent to the Tutton's salt solution to form a Tutton's salt/chelating agent solution; and
heating the Tutton's salt/chelating agent solution to form a cathode precursor material comprising a mixed metal composition of the Tutton's salt.

2. The method of claim 1, wherein combining a Tutton's salt exhibiting the chemical formula (NH₄)₂M(SO₄)₂·6H₂O comprises dissolving the Tutton's salt in ethylene glycol and water.

3. The method of claim 1, further comprising obtaining the Tutton's salt from one or more metal waste sources.

4. The method of claim 1, wherein M comprises one or more transition metals.

5. The method of claim 1, wherein M is one or more of Ni, Co, and Mn.

6. The method of claim 1, wherein adding a chelating agent to the Tutton's salt solution comprises adding one or more of ethylenediaminetetraacetic acid, citric acid, fulvic acid, phytic acid, gluconic acid, nitrilotriacetic acid, lactic acid, acetic acid, malic acid, oxalic acid, tartaric acid, lactic acid, picolinic acid, ascorbic acid, and formic acid to the Tutton's salt solution.

7. The method of claim 1, wherein heating the Tutton's salt solution comprises heating the Tutton's salt solution to a temperature of from about 100° C. to about 250° C.

8. The method of claim 1, wherein heating the Tutton's salt solution comprises precipitating the mixed metal composition of the Tutton's salt.

9. The method of claim 1, further comprising:
adding one or more metal sulfate salts to the Tutton's salt solution to adjust relative metal amounts of the cathode precursor material.

10. A method of preparing a cathode precursor material, the method comprising:
combining a Tutton's salt comprising the chemical formula (NH₄)₂M(SO₄)₂·6H₂O, wherein M comprises nickel and cobalt in water to form a Tutton's salt solution;
adding oxalic acid to the Tutton's salt solution to form a Tutton's salt/oxalic acid solution; and
heating the Tutton's salt/oxalic acid solution to form a cathode precursor material comprising nickel and cobalt.

11. The method of claim 10, wherein heating the Tutton's salt/oxalic acid solution to form a cathode precursor material comprises forming the cathode precursor material comprising the chemical formula NiₓMn_{y}Co_{(1-x-y)}(OH)₂.

12. The method of claim 10, further comprising:
combining the cathode precursor material with a lithium source and heating to form lithium-metal particles.

13. The method of claim 12, wherein combining the cathode precursor material with a lithium source comprises combining the cathode precursor material with one or more of LiOH and Li₂CO₃.

14. The method of claim 12, wherein heating to form lithium-metal particles comprises heating to a temperature of from about 400° C. to about 950° C.

15. The method of claim 12, wherein forming lithium-metal particles comprises forming particles of LiNiₓMn_{y}Co_{(1-x-y)}O₂.

16. The method of claim 12, wherein heating to form lithium-metal particles comprises forming the lithium-metal particles comprising lithium-Ni:Mn:Co particles comprising Ni:Mn:Co at a ratio of 8:1:1 Ni:Mn:Co or 6:2:2 Ni:Mn:Co.

17. A method of preparing a cathode precursor material, the method comprising:
dissolving a Tutton's salt in water or in ethylene glycol and water to form a Tutton's salt solution;
adding a chelating agent comprising one or more of citric acid and oxalic acid to the Tutton's salt solution to form a Tutton's salt/chelating agent solution; and
heating the Tutton's salt/chelating agent solution to form a cathode precursor material comprising a mixed metal composition.

18. The method of claim 16, wherein dissolving a Tutton's salt comprises dissolving a Tutton's salt prepared from a metal feedstock recovered from spent lithium-ion batteries.

19. The method of claim 17, wherein heating the Tutton's salt/chelating agent solution to form a cathode precursor material comprising a mixed metal composition comprises heating the Tutton's salt/chelating agent solution to form a cathode precursor material comprising nickel, cobalt, and manganese.

20. The method of claim 19, further comprising:
combining the cathode precursor material with a lithium source to form lithium-metal particles; and
disposing the lithium-metal particles on a substrate to form a cathode material comprising nickel, cobalt, manganese, and lithium.
